(19) United States
(12) Patent Application Publication
(10) Pub. No.: US 2025/0092640 A1
(43) Pub. Date: Mar. 20, 2025

(54) VALVE ARRANGEMENT FOR MOBILE WORKING MACHINES COMPRISING A HYDRAULIC CONSUMER

(71) Applicant: OILFIX GMBH, Köln (DE)

(72) Inventor: Berthold WINZ, Köln (DE)

(21) Appl. No.: 18/966,117

(22) Filed: Dec. 2, 2024

Related U.S. Application Data
(63) Continuation of application No. PCT/EP2023/059233, filed on Apr. 6, 2023.

(30) Foreign Application Priority Data
Jun. 3, 2022 (DE) 10 2022 114 096.2
Oct. 7, 2022 (DE) 10 2022 126 034.8

(51) Int. Cl. E02F 9/22

(52) U.S. Cl. CPC E02F 9/2285; E02F 9/226; E02F 9/2267

(57) ABSTRACT

A valve arrangement for a mobile working machine includes a hydraulic consumer with at least one directional control valve connected to a pressure line and a working line of the hydraulic consumer and including a hydraulic control line to move the at least one directional control valve to a first position, a pilot valve connected to the hydraulic control line, a pressure supply line, and a pressure reduction line. The pilot valve is structured to connect the hydraulic control line alternately to the pressure supply line and the pressure reduction line.

### CROSS REFERENCE TO RELATED APPLICATIONS

This application is a continuation application of International Application No. PCT/EP2023/059233, filed on Apr. 6, 2023, which claims the benefit of priority to German Patent Application No. 102022114096.2, filed on Jun. 3, 2022, and German Patent Application No. 102022126034.8, filed on Oct. 7, 2022. The entire contents of each of these applications are hereby incorporated herein by reference.

### BACKGROUND OF THE INVENTION

### 1. Field of the invention

The present invention relates to valve arrangements, uses for valve arrangements, mobile working machines, and methods for reducing or minimizing hydraulic oil loss in mobile working machines.

### 2. Description of the Related Art

Mobile machines with hydraulic systems, in particular mobile hydraulic construction machines, are used in a variety of ways on construction sites for demolition and dismantling work. Such mobile machines are also used in civil engineering and forestry. Examples of mobile machinery include cranes, excavators, as well as material handlers, forestry machines and the like. In the demolition sector, so-called “longfront” excavators or demolition excavators are used. The long booms and arms make mobile hydraulic construction machines a good tool for using hydraulic attachments for the respective purpose, even at heights of over 20 m. When operating mobile hydraulic construction machines, the hydraulic hoses, which form the hydraulic system of the attachments, are exposed to external influences due to ageing processes or the weather, which can cause damage to the hydraulic hoses. However, other and much more unpredictable sources of damage are external mechanical effects on the hydraulic hoses caused by working in areas that are not completely visible. The excavator's operating personnel cannot see every part of the mobile hydraulic construction machine's arm during operation, which means that hydraulic hoses can get caught on sharp objects on the construction site, for example, or be punctured, torn off, cut open or crushed and thus damaged. Due to unavoidable ageing processes on the one hand and unforeseeable external influences on the other, oil leaks may occur in the hydraulic hoses during regular operation of the construction machine. It is known from EP 25 47 912, among others, to interrupt lines of the hydraulic system on the attachment that are damaged by pipe ruptures so that the attachment does not perform any uncontrolled movements, remains in a fixed position, and does not pose any safety risks on the construction site. However, the hydraulic system is only interrupted on the side of the attachment, which is critical, as the long booms and arms of mobile hydraulic construction machines also require long hydraulic lines that have to be routed to the end of the arm to the attachment, so that in the event of an oil leak, over 400 liters of oil can often escape in less than half a minute and hit the ground on the construction site. The loss of the often very hot oil not only means additional costs due to the replacement of the lost oil, but also considerable environmental pollution of the construction site and often a considerable risk to people.

The same applies to the use of harvesters in forestry, some of which carry grapples on long booms or boom assemblies for gripping tree trunks, which, in addition to the hydraulic unit for the grapple, are also equipped with a hydraulic motor for rotating the grapple.

### SUMMARY OF THE INVENTION

Example embodiments of the present invention provide reliable, relatively simply constructed valve arrangements and environmentally friendly hydraulic working machines as well as methods for reducing or minimizing hydraulic oil loss in mobile working machines in the event of leakage of a working line and a corresponding use of a valve arrangement.

According to an example embodiment of the present invention, a valve arrangement for a mobile working machine with a hydraulic consumer includes at least one directional control valve connected to a pressure line and a working line of the hydraulic consumer and includes a hydraulic control line structured to transfer the at least one directional control valve to a first position, a pilot valve connected to the hydraulic control line, a pressure supply line, and a pressure relief line, the pilot valve being structured to connect the hydraulic control line alternately to the pressure supply line and the pressure relief line.

The valve arrangement allows the directional control valve to be moved safely to a shut-off position in the event of a leakage in the working line and reduces or prevents oil from escaping from the leak.

Preferably, the first position of the at least one directional control valve is a closed position in which the flow is blocked in both directions. The pilot valve can then ensure that the directional control valve remains in the blocked position.

Preferably, the at least one directional control valve is biased by a spring into the first position and includes two pilot lines which are connected to a working chamber opposite the spring, with a first pilot line being connected to the pressure line and a second pilot line being connected to the working line. The pilot control lines enable the directional control valve to be moved to an open position when the hydraulic consumer is activated. The pilot control lines or the working chamber can also be active surfaces that cause the directional control valve to move when pressure is applied.

The pilot valve can be a 3/2-way valve or 4/2-way valve, for example.

Preferably, the pilot valve can be actuated electrically and can connect the pressure supply line to the hydraulic control line in a rest position and the control line to the pressure reduction line in an actuated position. However, it is also conceivable to actuate the pilot valve in another way, in particular wirelessly.

The pilot valve is preferably electrically actuated in a working position and can be de-energized by an emergency stop switch. The emergency stop switch can be arranged in a working cabin of the working machine so that it can be operated manually.

If the hydraulic consumer includes two working lines, as for example, in a double-acting hydraulic cylinder, the valve arrangement preferably includes a first directional control valve and a second directional control valve, which are each connected to a pressure line and a working line of the common hydraulic consumer, the hydraulic control lines being connected to each other in such a way that the control lines pilot the two directional control valves into the closed position when these are pressurized starting from the pilot valve. The directional control valves preferably both include the above-mentioned features. By connecting the control lines, both directional control valves are actuated by a single pilot valve. It is also conceivable to use two pilot valves. The pilot valves can then be connected electrically or communicate with each other wirelessly by radio or other methods or devices.

In one example embodiment, the valve arrangement may include a shuttle valve with a first blockable inflow and a second blockable inflow and with an outflow. The first blockable inflow of the shuttle valve is connected to a first pressure line of the first directional control valve, the second blockable inflow of the shuttle valve is connected to a second pressure line of the second directional control valve and the outflow of the shuttle valve is connected to the pressure supply line, and the shuttle valve is structured such that the pressure line with a highest pressure can be connected to the pressure supply line.

However, it is also possible to connect the pressure supply line to the pressure line and the working line via branches arranged in parallel or substantially in parallel and each including a non-return valve structured such that a highest pressure present in the pressure lines and the working lines is directed to the pressure supply line.

The pressure reduction line can be a tank line (return line) that can be connected to a tank.

However, it is also conceivable that the pressure reduction line is connected to the pressure line and the working line via branches arranged in parallel or substantially in parallel and each include a non-return valve that opens when pressure is applied in the pressure reduction line to one of the pressure lines and the working lines with the lowest pressure to reduce the pressure. In this example embodiment, no return line is required, which can be advantageous if the valve arrangement is used at a great distance from the upper structure.

The first directional control valve and/or the second directional control valve can be a 2/2-way valve such that a hydraulic oil flow in both directions is blocked in the blocking position and a hydraulic oil flow in both directions is possible in a flow-through position.

Furthermore, the use of a valve arrangement described above in a working line of a hydraulic consumer in a mobile working machine is provided in order to shut off the working line when a leakage occurs in the working line and to largely prevent hydraulic oil from escaping from the leak.

In addition, a mobile working machine is provided, including a lower structure, an upper structure, and a boom assembly, as well as a hydraulic system including a hydraulic pump, a volume control valve, a hydraulic consumer and at least two hydraulic lines. The volume control valve is structured to regulate an oil flow through at least one of the hydraulic lines in order to control the hydraulic consumer. The at least one of the hydraulic lines includes a directional control valve which is structured to close the hydraulic line in the event of leakage. The boom assembly can include two or more links, in particular a boom and arm. The directional control valve can, for example, be a slide valve, seat valve, plate valve or similar.

Preferably, the directional control valve is arranged between the volume control valve and the hydraulic consumer, as hydraulic oil can escape from the leakage point even when the volume control valve is closed, for example, if post-suction valves are used in a bypass bridging the volume control valve to prevent cavitation.

Preferably, the mobile working machine includes a valve arrangement as described above and the directional control valve is a portion of the valve arrangement.

In one example embodiment, the hydraulic consumer includes a hydraulic cylinder, which preferably is double-acting in particular. In this case, as described above, there is one directional control valve in each of the hydraulic lines. It is also conceivable to provide more than one directional control valve or more than one valve arrangement in order to protect the hydraulic lines at different points. In addition, several control sections of the mobile working machine can each have such a valve arrangement, i.e., a large number of hydraulic lines to different hydraulic consumers can be protected as required.

Furthermore, a method for reducing or minimizing hydraulic oil loss in a mobile working machine described above in the event of a leakage in a working line is provided, which includes, if a leakage occurs in the hydraulic line between the hydraulic consumer and the directional control valve, move the directional control valve to a shut-off position to shut off the hydraulic line; ensure that a locking position is maintained until the leakage has been rectified; after eliminating the leakage, return the directional control valve and/or the valve assembly to an initial state before the leakage or to an initial position.

In contrast to other valves or valve arrangements that close hydraulic lines, this method allows the mobile working machine to continue to be operated and moved, except for the controller that is assigned to the leakage line. Since it is ensured or can be ensured that the shut-off position is maintained until the leakage has been rectified and the working line has been repaired, hydraulic oil can be reliably prevented from escaping from the working line. Valves that do not have this option are not suitable as emergency stop devices to prevent large quantities of hydraulic oil from escaping from a leak. The directional control valve or valve assembly is preferably returned to the state it was in before the leakage and the line was shut off without tools and without replacing or renewing parts/components. It is particularly preferable for the initial state to be brought about automatically, for example, after release by an operator. Such a release can include an input in an operation interface, actuation of a switch, or the like.

Further possible example embodiments of the valve arrangements, the driven machines and the methods are described below.

Because a valve arrangement for a working machine, in particular, a construction machine including an oil-hydraulic tool, is provided with a first directional control valve, in particular a first 2/2-way valve, which is connected to a first pressure line and a first working line, a second directional control valve, in particular a second 2/2-way valve, connected to a second pressure line and a second working line, a 4/2-way valve connected to an inlet pressure line, an outlet line, a first control line and a second control line, a shuttle valve with a first blockable inflow and a second blockable inflow as well as with an outflow, the 4/2-way valve can be actuated electrically and connects the inlet pressure line to the first control line in a rest position and connects the first control line to the outlet line in an actuated position, and both the first directional control valve and, essentially simultaneously, the second directional control valve can be closed when the 4/2-way valve is in the rest position. The rest position is preferably de-energized, i.e., can be engaged by an emergency stop switch or due to an electrical disconnection.

The second control line is preferably permanently blocked and connected to the inlet pressure line when the 4/2-way valve is in the actuated position.

Furthermore, if the first blockable inlet of the shuttle valve is connected to the first pressure line, the second blockable inlet of the shuttle valve to the second pressure line and the outlet of the shuttle valve to the inlet pressure line, both 2/2-way valves are closed in the rest position of the 4/2-way valve due to the pressure in the higher-pressure pressure line. For this purpose, it is advantageous that the control line is connected to the first 2/2-way valve and the second 2/2-way valve in such a way that it advances the first and second 2/2-way valves to the closed position when the control line is pressurized.

An emergency stop function can be achieved particularly easily and reliably if the 4/2-way valve is electrically actuated in a working position and can be de-energized by an emergency stop switch. It is particularly advantageous for the emergency stop switch to be arranged in a working cabin of the machine so that it can be operated manually. The emergency stop function can be provided in the event of a leakage in the working line.

Because in a generic working machine it can be provided that the at least two hydraulic lines are each assigned at least one directional control valve, in particular a 2/2 directional control valve, which is structured to close the hydraulic line in an emergency, the at least one directional control valve of each of the two hydraulic lines is arranged in the hydraulic line in the area of the boom or in the area of the lower structure in the hydraulic line between the valves and the oil-hydraulic tool, the leakage of hydraulic oil from the upstream hydraulic system of the working machine can be largely prevented in the event of a hydraulic line breakage in the area of the boom.

The directional control valves are preferably hydraulically pilot-controlled. In particular, the directional control valves may have an opening pressure of between about 1 bar and about 10 bar, especially between about 1.5 bar and about 5 bar and particularly preferably within the usual tolerances of around about 2 bar, for example. This keeps the pressure loss relatively low. The directional control valves are also preferably designed for working pressures between about 200 bar and about 450 bar, preferably between about 300 bar and about 450 bar and in particular about 350 bar to about 420 bar, for example. The pilot valve is preferably designed for working pressures of up to about 500 bar, for example. Finally, the valve arrangement is preferably designed for a flow rate (volume flow) of about 50 liters per minute (1/min) to about 2500 l/min, in particular about 600 l/min to about 1500 l/min and particularly preferably about 700 l/min to about 1350 l/min, for example.

The valve arrangements are preferably modular so that, for example, one directional control valve can be mounted on one side of the boom and the other directional control valve on the other side of the boom, regardless of the specific shape of the valve arrangement.

A particularly advantageous example embodiment is one in which the directional control valves of the valve arrangement can be connected directly to the shut-off valves or quick-change connections of the working machine or can even replace them. Ball valves are often fitted in the boom area of an excavator, which must be closed to change the attachment tool. A valve arrangement according to an example embodiment of the present invention can be mounted instead of these ball valves, so that there is an additional benefit due to the automatic closing of the valves when the excavator is switched off and a saving in working time, in addition to the increased operational safety.

It is conceivable that the directional control valves are closed by actuating an emergency stop switch and reopened by actuating the emergency switch again once the leakage has been rectified. However, it is also possible for the directional control valves to be automatically controlled by a sensor that detects a pressure drop or to close hydraulically fully automatically in the event of a pressure drop.

If the at least two hydraulic lines of the working machine are located in a protected area on an upper side of the boom, are defined by ducts or pressure medium pipes and the respective directional control valve is arranged in this protected area, the probability of damage to the hydraulic lines on the pressure side of the valve arrangement and the valve arrangement itself is reduced, especially in demolition operation. Preferably, the respective directional control valve or 2/2-way valve is integrated in a valve block, which can be flange-mounted to a duct, for example.

Preferably, the at least two hydraulic lines directly supplying the tool are each attached to the tool at a first attachment point and to the boom at a second attachment point and include a flexible hose bend between the two attachment points, with the at least one directional control valve or 2/2-way valve being arranged outside the flexible hose bend in the area of the boom. The two directional control valves are preferably connected to each other hydraulically and/or electrically.

If the second attachment point of each hose bend is located on the respective assigned directional control valve, additional fittings or passive outlet safety devices are not required in this area.

Preferably, the oil-hydraulic tool is an excavator tool, a demolition shear, a forestry tool or a civil engineering tool. With these tools and their usual area of application, there is a particularly high risk of a line breakage due to damage during operation. The safety device described in this respect is particularly advantageous if the lower structure is self-propelled.

The emergency that leads to a shut-off of the 2/2-way valves is advantageously a breakage of at least one hose bend, in particular in the immediate vicinity of a tool mounted on the arm.

Preferably, such a working machine includes a valve arrangement with the features described above.

A method of protecting a working machine as described above includes, if a leakage occurs in at least one of the hydraulic lines between the oil-hydraulic tool and the valves, move the at least one directional control valve or 2/2-way valve into a shut-off position (rest position) to shut off the at least two hydraulic lines, after the leakage has been rectified, transfer at least one directional control valve or 2/2 directional control valve to the initial position.

This means that if a hydraulic line breaks, the amount of oil escaping can be effectively limited, even if the hydraulic pump of the working machine continues to operate. Damage to the hydraulic pump due to idling can thus be prevented. The process also helps to protect workers and hydraulic oil can be saved (resource conservation).

In particular, the oil-hydraulic tool can include a double-acting hydraulic cylinder and the two hydraulic lines connected to the double-acting hydraulic cylinder can be shut off.

When using a valve arrangement described above in a working machine to prevent oil from escaping uncontrolled from the hose breakage point in the event of a hose breakage in the area of a hose bend of the two working lines, a particularly high level of reliability is achieved with simple actuation in an emergency.

In addition, a mobile hydraulic construction machine can be provided with an upper structure, a lower structure, a boom assembly, preferably with a boom and intermediate boom and with an arm, an attachment connected to the arm and a hydraulic system to move the boom assembly and the attachment. The hydraulic system includes at least one pump and an additional valve block to regulate the oil flow of at least two hydraulic lines connecting the attachment to the pump in order to control the attachment. At least one emergency stop valve is assigned to each of the hydraulic lines, which is structured to close the hydraulic line in an emergency, the at least one emergency stop valve being arranged in the boom assembly in the hydraulic line and/or in the upper structure on the flow side of the additional valve block away from the pump. The emergency stop valves can be represented by the valve arrangements described above. Emergency stop valves can also include shut-off devices such as slide valves.

The emergency stop valves enable the hydraulic lines to be closed in the event of a leakage to reduce or prevent hydraulic oil from escaping to a large extent. It is particularly easy to retrofit the emergency stop valves in the upper structure area. The use of emergency stop valves in the area of the arm is advantageous, as this is of great benefit in the event of leaks in the area between the boom assembly and the attachment.

Preferably, the at least two hydraulic lines are located in a protected area on an upper side of the arm or are defined by channels, and the respective emergency stop valve is located in this protected area. The phrase “protected area” indicates that the hydraulic lines are rigid pipes, in particular made of metal, which are protected from external influences. These protected areas must be distinguished from areas of the hydraulic line with flexible hoses, which can quickly tear or be damaged.

The hydraulic lines are preferably attached to the attachment at a first attachment point and to the arm at a second attachment point and define a flexible hose bend between the two attachment points, and the at least one emergency stop valve is preferably arranged outside the flexible hose bend in the area of the handle. During regular work with the mobile hydraulic construction machine, oil leaks often occur at the flexible hose bends, as their nature makes them susceptible to getting stuck at points on the construction site, for example. However, the hose bends are beneficial for the use of the construction machine, as without the hose bends it would not be possible to move the boom assembly and attachments to any great extent. Closing the emergency stop valves and thus the hydraulic lines and the hydraulic system prevents oil from escaping in the event of a leak.

Preferably, the emergency stop valves are electronically controlled solenoid valves, which are particularly cost-effective. The emergency stop valves can be 2-way valves, as described above, and the hydraulic system preferably includes at least one return line connecting the emergency stop valves to a hydraulic oil tank from which the hydraulic system is fed by the pump. In this case, it is not necessary to communicate with the additional valve block, as the hydraulic oil flow through the hydraulic lines in the area of the additional valve block does not have to be interrupted.

In a further example embodiment, the mobile hydraulic construction machine includes an emergency stop actuator to communicate with the emergency stop valves and/or optionally additionally with the additional valve block and is operable to close the emergency stop valves when actuated.

Preferably, the emergency stop actuator is located in a driver's cab of the mobile hydraulic machine. If the driver of the mobile hydraulic construction machine detects a leak, the operator can actuate the emergency stop device and thus prevent the hydraulic oil from continuing to escape at the point of breakage.

Preferably, at least one sensor is assigned to the at least two hydraulic lines to detect a leakage in the at least two hydraulic lines and to communicate with the emergency stop valves and/or the additional valve block. In this case, the emergency stop valves can be closed automatically in the event of a leakage and pressure drop in the hydraulic line.

In an example embodiment, the mobile hydraulic construction machine is a long-boom excavator with a reach height in the range of about 15 m to about 90 m and, in particular, a weight class between about 25 t and about 400 t, for example. However, it can also be a mini excavator up to about 10 t or a small excavator up to about 18 t, for example.

Furthermore, a method for controlling a mobile hydraulic construction machine including an upper structure, a lower structure, a boom assembly with an arm, an attachment connected to the arm and a hydraulic system to move the boom assembly and the attachment is provided. The hydraulic system includes at least one pump and one valve block, in particular an additional valve block, and at least two hydraulic lines connecting the attachment to the pump. The valve block or the additional valve block is connected to the at least two hydraulic lines. The method includes detecting a leakage in one of the hydraulic lines between the attachment and the valve block or additional valve block, and switching at least one emergency stop valve in the boom assembly and/or in the upper structure on a flow side of the valve block or the additional valve block remote from the pump in one of the at least two hydraulic lines to shut off the at least two hydraulic lines.

Preferably, the emergency stop valves are 2-way valves and the hydraulic system includes at least one return line, and the method further includes connecting the hydraulic line to the return line by the emergency stop valve such that the return line is connected to a hydraulic oil tank from which the hydraulic system is fed by the pump.

Preferably, the method includes actuating the valve block or the additional valve block to shut off the at least two hydraulic lines with a predetermined time delay.

Preferably, the method includes performing detecting via sighting by an operator or by a sensor arranged in the hydraulic line.

Preferably, a mobile hydraulic construction machine includes an emergency stop actuator which communicates with the emergency stop valves and/or the valve block or additional valve block and the method further including manually the emergency stop device.

The mobile hydraulic construction machine can be designed as described above.

Example embodiments of the present invention are explained in more detail below with reference to the drawings.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 shows a spatial representation of a mobile hydraulic construction machine according to an example embodiment of the present invention.

FIG. 2 shows a top view of the mobile hydraulic construction machine shown in FIG. 1.

FIG. 3 shows a schematic representation of an example embodiment of a hydraulic system of an attachment of the mobile hydraulic construction machine from FIG. 1.

FIG. 4 shows a schematic representation of a further example embodiment of a hydraulic system of an attachment of the present invention.

FIG. 5 shows a shut-off position of a valve arrangement of an example embodiment of the present invention.

FIG. 6 shows a valve arrangement of a further example embodiment in the shut-off position of the present invention.

### DETAILED DESCRIPTION OF THE EXAMPLE EMBODIMENTS

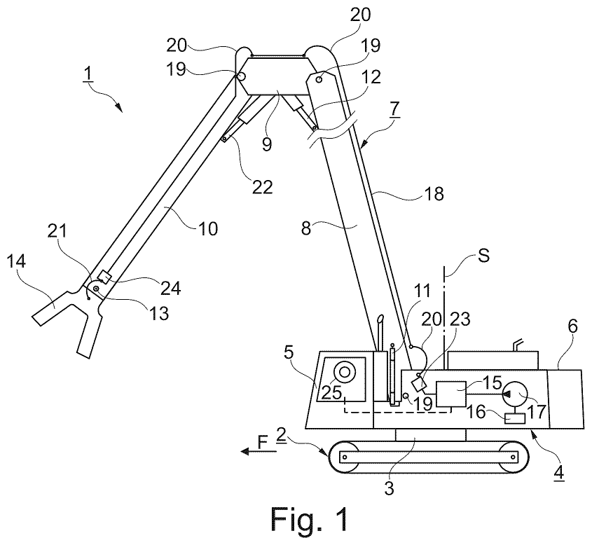

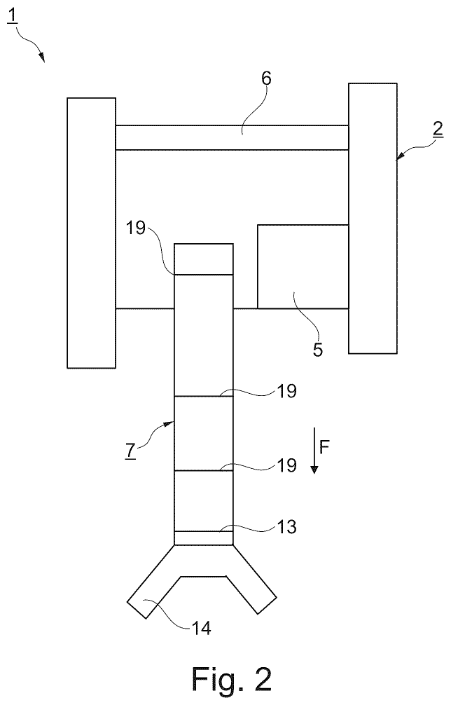

FIG. 1 shows a mobile working machine, in particular a hydraulic construction machine 1 according to an example embodiment as a long-arm boom excavator with a lower structure 2, which is connected to an upper structure 4 via a slewing mechanism 3 that can be rotated about a slewing axis S. The slewing mechanism 3 enables a controlled slewing movement between the upper structure 4 and the lower structure 2 around the slewing axis S. In general, a distinction can be made between mobile excavators and crawler excavators. On the one hand, the lower structure 2 can have tires in a chassis and is referred to as a mobile excavator, whereby mobile excavators are only used in the weight class up to 25 t, and on the other hand, the lower structure 2 can have tracks, so that crawler excavators are referred to, which are used in all weight classes. Mobile and crawler excavators are to be distinguished as self-propelled land vehicles from other types of excavators such as floating excavators. In the present example embodiment, the long arm excavator 1 is realized as a crawler excavator, which is in a weight class between about 25 t and about 400 t typical for demolition work, for example. The upper structure 4 includes a driver's cab 5 at its end in the direction of travel F (straight ahead) and a counterweight 6 opposite the driver's cab 5. FIGS. 1 and 2 show a three-part boom assembly 7, which is attached to the supper structure 4 next to or behind the driver's cab 5. The boom assembly 7 includes three links 8, 9, 10 arranged one behind the other. A first portion 8, called the boom, a second portion 9, called the intermediate boom, and a third portion furthest from the upper structure, called the arm 10, whereby two consecutive portions are pivotably mounted to each other by bolts, for example. The boom assembly 7 further includes a boom cylinder 11, which can move the first link 8, and an intermediate boom cylinder 12, which can move the second link 9 of the boom assembly 7. Furthermore, an arm cylinder 22 is provided which can be driven to move the arm 10. An attachment 14 is attached to the free end of the arm 10, through which an arm head bolt 13 passes. This connection preferably be made by a quick coupler. The attachment 14 and the quick coupler can also be pivoted about the pivot axis defined by the arm head bolt 13. In this example embodiment, the attachment 14 is a gripping tool, but all hydraulic attachments such as, for example, shears can be used.

The mobile hydraulic construction machine 1 includes a hydraulic system that drives the boom cylinder 11 and the intermediate boom cylinder 12 as well as the arm cylinder 22 via hydraulic oil. The hydraulic oil flow and the associated movements are controlled and monitored by a main valve block of the hydraulic system, not shown, located in the upper structure 4. The main valve block includes valves that regulate a supply quantity of hydraulic oil to one of the hydraulic cylinders. Furthermore, the main valve block is operable to control a hydraulic slewing drive of the slewing gear 3 and a hydraulic travel drive for the tracks of the lower structure 2. An additional valve block 15, a hydraulic oil tank 16 and a hydraulic pump 17 also belong to the hydraulic system and are located in the upper structure 4. The hydraulic pump 17 supplies the hydraulic oil of the hydraulic system and is connected to the main valve block and the additional valve block 15 via a hydraulic connection. Several pumps can be used in the hydraulic system if the performance of one pump is not sufficient for the required application or if the system is to be designed redundantly. The additional valve block 15 controls and regulates a hydraulic oil flow to the attachment 14. Hydraulic lines 18 lead from the additional valve block 15 to the attachment 14. FIG. 1 shows only one hydraulic line 18, but depending on the attachment used and the type of construction machine, there may be several, but at least two hydraulic lines 18. The type of attachment 14 and the movement that it can perform define the number of (used and connected) hydraulic lines 18. The hydraulic line 18 is preferably provided in the area of bolts 19 of the boom assembly 7, between the upper structure 4 and the first link 8, and between the first link 8 and the second link 9 and between the second link 9 and the arm 10, by flexible hose lines arranged in a bend, also called boom hose bends 20. A flexible hose bend 21 is also preferably provided between a first attachment point on the attachment 14 and a second attachment point on the arm 10. The flexible boom hose bends 20 and the flexible hose bend 21 make it possible for the individual links of the boom assembly 7 to pivot about the longitudinal axis of the bolts 19 without the hydraulic line 18 being interrupted or ruptured. The hose bend 21 and the boom hose bends 20 are provided for each additional hydraulic line 18 (not shown). The portions of the hydraulic line 18 that extend centrally along the links of the boom assembly 7 away from the swivel axles or the bolts 19 are preferably rigid metal tubes. The ends of the metal tubes are each connected to a flexible hose line to define the hydraulic line 18. The metal tubes provide a protected area in which the hydraulic line 18 is protected from external damage. In the hydraulic line 18 shown, there are two emergency stop valves 23, 24 between the additional valve block 15 and the attachment 14. The emergency stop valves 23, 24 of the at least two hydraulic lines 18 are divided into first emergency stop valves 23 and second emergency stop valves 24 and are shown schematically as a rectangle in FIG. 1. The first emergency stop valve 23 and the second emergency stop valve 24 can close the corresponding hydraulic line 18 at the respective position. This can ensure that the emergency stop valve 23, 24 located on the side near the additional valve block of an occurring oil leakage reduces or prevents the hydraulic oil located between this emergency stop valve 23, 24 and the hydraulic pump 17 or the hydraulic oil tank 16 in the hydraulic lines 18 from escaping. The first emergency stop valve 23 is located in the upper structure 4 on the flow side of the additional valve block 15 remote from the pump. The second emergency stop valve 24 is located in the hydraulic line 18 in the area of the arm 10 outside the hose bend 21. A position that is located directly upstream or downstream of the flexible hose line in the area of the arm head bolt 13 in the direction of flow is particularly preferred, as shown in FIG. 1. Experience has shown that the hose lines often leak in the area of the arm head bolt 13. The position of the second emergency stop valve 24 described above makes it possible to maintain the maximum possible amount of hydraulic oil in the hydraulic lines 18 in the event of such a leakage. If an oil leakage occurs in the hose bend 21, closing the second emergency stop valve 24 allows the oil in the hydraulic line 18 between the second emergency stop valve 24 and additional valve block 15 to remain in the hydraulic lines 18 and prevents it from escaping. It is conceivable to use further emergency stop valves which, for example, protect the boom hose bends 20 of the second link 9 against leakage. Preferably, at least one emergency stop valve 23, 24 is provided per hydraulic line 18. The first emergency stop valve 23 prevents the majority of the hydraulic oil from escaping in the event of a leakage in the flexible hose line in the area of the support head pin 13. The emergency stop valves 23, 24 clearly differ from conventional pipe rupture safety devices, which are now installed as standard in mobile hydraulic construction machines. The pipe rupture safety valves, which are not shown, are installed on the attachment 14 and prevent uncontrolled movements of the attachment 14 in the event of pipe ruptures in order to protect operating personnel and construction site personnel. They maintain the pressure of the hydraulic oil in the attachment 14 or the working chambers of the hydraulic cylinders installed in it and allow the attachment 14 to remain in a fixed position. The emergency stop valves 23, 24 interrupt the hydraulic system at at least one point towards the additional valve block 15. The hydraulic oil in the hydraulic line between the break point and the emergency stop valve 23, 24 escapes. However, the emergency stop valve 23, 24 prevents large quantities of hydraulic oil from escaping and thus contributes to environmental protection during demolition work.

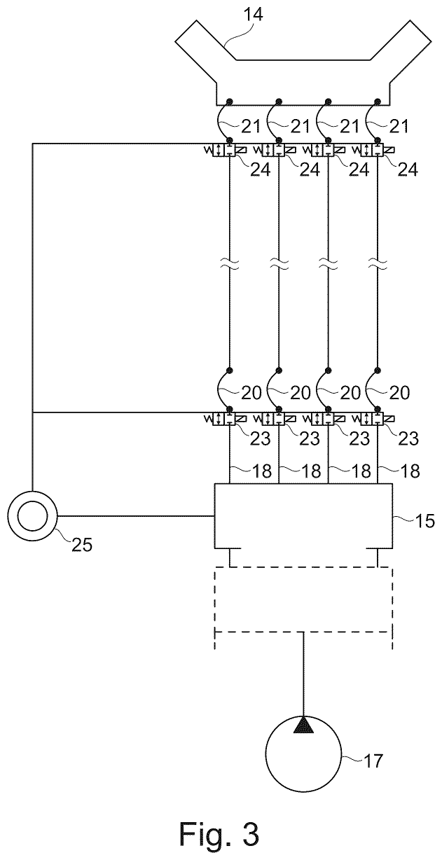

FIG. 3 shows a portion of a hydraulic system, which is only shown schematically and is used to control the movement of the attachment 14. The hydraulic valves of the additional valve block 15 are electrically pilot-controlled to move the attachment 14, which is not shown in the figure. The hydraulic pump 17 supplies the auxiliary valve block 15 with the oil pressure required to control the attachment 14 or its hydraulic cylinder. The additional valve block 15 regulates the volume flow of the hydraulic oil through the four hydraulic lines 18 shown as an example and can therefore control the movement of the attachment 14. There is a first emergency stop valve 23 and a second emergency stop valve 24 per hydraulic line 18. The first emergency stop valves 23 and the second emergency stop valves 24 are each located in two different sections of the hydraulic line 18. The hose bends 20 closest to the additional valve block and the flexible hose bends 21 in the area of the arm head bolt 13 are shown.

On the one hand, the first emergency stop valves 23 are arranged in the upper structure 4, in an upper structure section of the respective hydraulic line 18, which is located on the flow side of the additional valve block 15 remote from the pump, and on the other hand, the second emergency stop valves 24 are arranged in a boom assembly section of the respective hydraulic line 18, which is located outside the upper structure 4 and in the area of the arm 10 outside the flexible hose bends 21, as already described above. The emergency stop valves 23, 24 are open during regular operation of the mobile hydraulic construction machine 1 so that the hydraulic oil can flow unhindered through the emergency stop valves 23, 24. The emergency stop valves 23, 24 are controlled by an emergency stop actuator 25. When the emergency stop actuator 25 is actuated, the hydraulic lines 18 are closed by the emergency stop valves 23, 24 and the hydraulic oil flow is stopped. The emergency stop device 25 communicates electronically with the additional valve block 15 and switches the emergency stop valves 23, 24.

After a leakage has been detected in one of the hydraulic lines 18 between the attachment 14 and the additional valve block 15, the emergency stop valves 23, 24 are switched and the hydraulic lines 18 are shut off. FIG. 3 shows the closed state of the emergency stop valves 23, 24, which is achieved by actuating the emergency stop actuator 25.

In an example embodiment, the emergency stop valves 23,24 are electronically controlled solenoid valves.

In an example embodiment, the leakage is detected by the operating personnel and the operating personnel then actuates the emergency stop actuator 25 and the emergency stop valves 23, 24 are switched and shut off the hydraulic lines 18. The detection can also be carried out by a sensor which is assigned to the hydraulic lines 18 and the emergency stop actuator 25 can then be actuated automatically.

In an example embodiment, the additional valve block 15 is first activated by actuating the emergency stop actuator 25 and the additional valve block 15 shuts off the at least two hydraulic lines 18. The emergency stop valves 23, 24 are then switched and the hydraulic lines 18 are closed with a predeterminable time delay.

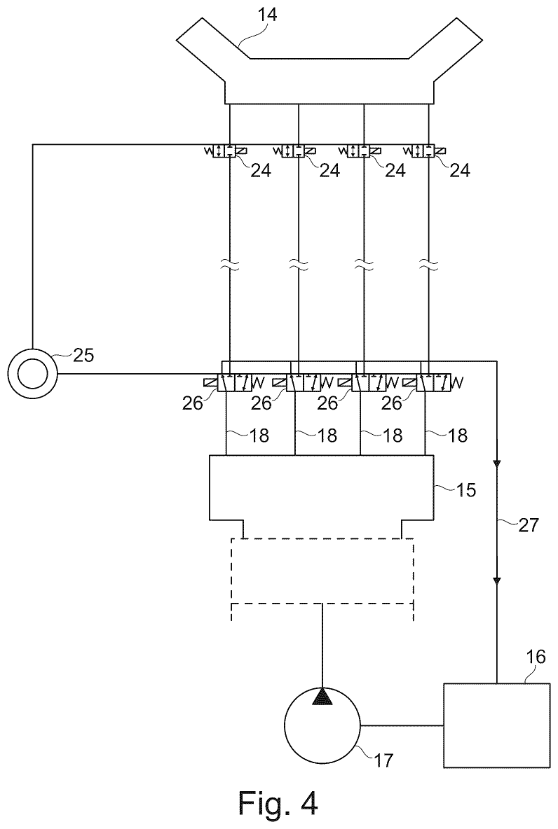

FIG. 4 shows a further example embodiment of a portion of the hydraulic system largely analogous to FIG. 3. In this case, the attachment 14 is hydraulically pilot-controlled by a low-pressure line. The boom hose bends 20 and the hose bends 21 have not been shown. The differences are explained below. In the example embodiment shown in FIG. 4, the first emergency stop valves 23 in the upper structure section of the hydraulic lines 18 are realized by 2-way valves 26, which can be connected to the hydraulic oil tank 16 of the hydraulic system via a return line 27. In regular operation, the second emergency stop valves 24, which in one example embodiment are electronically controlled solenoid valves, are open in the boom assembly section and the 2-way valves 26 in the upper structure section are in a first switching position, which allows hydraulic oil to flow from the additional valve block 15 via the hydraulic line 18 to the attachment 14.

After an oil leakage has been detected by operating personnel or a sensor, the second emergency stop valves 24 in the boom assembly section of the hydraulic lines 18 are switched and closed by actuating the emergency stop actuator 25 and the 2-way valves 26 switch to a second switching position shown, in which hydraulic oil flows from the additional valve block 15 via the return line 27 into the hydraulic oil tank 16.

It is conceivable to use more than two emergency stop valves 23, 24 per hydraulic line 18.

In both versions of the hydraulic systems, one electrically and one hydraulically pilot-controlled, the detection of an oil leakage can be carried out by operating personnel or a sensor. The emergency stop actuator 25 can, for example, be provided as an actuation button in the driver's cab 5 or on the boom assembly 7 or be accessible via a controller of the mobile hydraulic construction machine 1, which has the necessary operating interfaces to control the mobile hydraulic construction machine 1. By actuating the emergency stop actuator 25, the emergency stop valves 23, 24 are switched and the hydraulic oil flow is stopped. By actuating the emergency stop actuator 25 again, the emergency stop valves 23, 24 can be switched back and the hydraulic lines 18 to the attachment 14 can be opened again. The emergency stop valves 23, 24 are switched back when the oil leakage in the hydraulic lines 18 has been rectified. If the leakage is detected by a sensor, it is conceivable that an alarm is issued, whereupon the operating personnel can actuate the emergency stop actuator 25. However, it is also possible that the emergency stop valves 23, 24 and/or the additional valve block 15 are automatically activated by the sensor that detects a pressure drop. In a further example embodiment, it is intended to use emergency stop valves which close automatically in the event of a pressure drop in the hydraulic line 18.

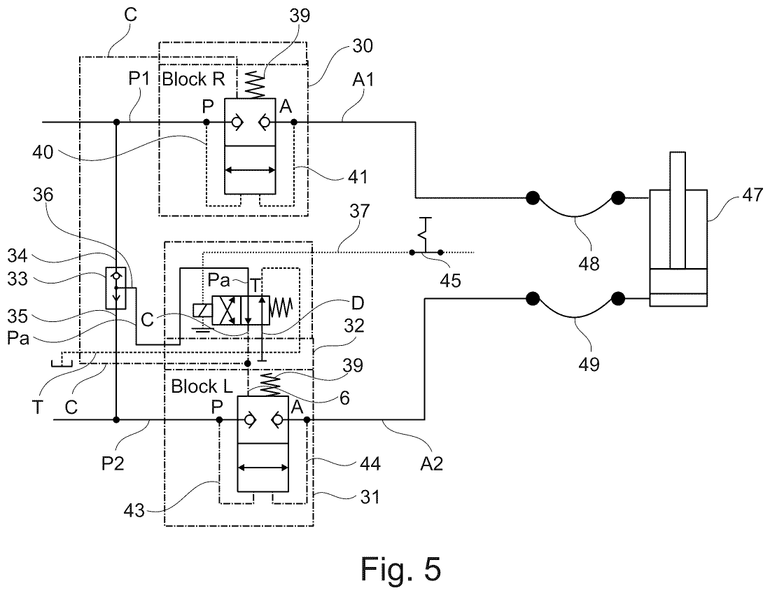

Finally, FIG. 5 shows a valve arrangement with two emergency stop valves. The valve arrangement includes a first 2/2-way valve 30, which is connected to a first pressure line P1 and a first working line A1, a second 2/2-way valve 31, which is connected to a second pressure line P2 and a second working line A2, a 4/2-way valve 32, which is shown here in an assembly with the second 2/2-way valve 31 and which is connected to an inlet pressure line Pa, an outlet line T, a first control line C and a blocked connection D, and a shuttle valve 33 with a first blockable inlet 34 and a second blockable inlet 35 and with an outlet 36. The 2/2-way valves are emergency stop valves within the meaning of the above description and can be deployed and used accordingly.

The 4/2 directional control valve 32 can be electrically actuated via an electrical line 37 and, in the rest position shown in FIG. 5, connects the inlet pressure line Pa to the first control line C and the outlet line T to the permanently blocked connection D of the 4/2 directional control valve 32. In an electrically actuated position, the inlet pressure line Pa is connected to the permanently blocked connection D and thus shut off. The control line C is connected to the drain line T and is thus essentially depressurized.

The control line C is connected to the first 2/2-way valve 30 and the second 2/2-way valve 31 in such a way that it advances them to the closed position when the control line C is pressurized.

In the rest position shown, the 2/2-way valve 30 and the 2/2-way valve 31 are preloaded into the closed position by a spring 39 (N C). Both valves are controlled via the inlet pressure in the connection lines P1 and P2 and the working lines A1 and A2. For this purpose, a pilot line 40 is provided in the 2/2-way valve 30, which extends from the pressure line P1 to a working chamber opposite the spring 39 (not shown). A further pilot line 41 extends from the working line Al to the same working chamber. The spring 39 and the geometric design of the movable valve and the working chamber (not shown) are selected such that the 2/2-way valve 30 switches to the open position against the force of the spring 39 at an inlet pressure of approximately 2 bar. Electrical actuation of the directional control valve 30 is not required and not provided. It is purely pressure-controlled. The same applies to the 2/2 directional control valve 31, in which a pilot line 43 extends from the pressure line P2 and a pilot line 44 from the working line A2 to a corresponding working chamber. This valve is also pressure-controlled and opens, for example, when an inlet pressure of 2 bar is applied.

In the rest position shown in FIG. 5, the two 2/2-way valves 30 and 31 are therefore closed. When pressure builds up in the pressure lines P1 or P2, the respective 2/2-way valve is pilot-controlled into the open position via the pilot lines 40 or 43. At the same time, however, the higher pressure is applied to the outlet 36 of the shuttle valve 33 via the connections 34 or 35 of the shuttle valve 33. This higher pressure is then present at the inlet pressure line Pa and is applied to the control line C via the 4/2-way valve 32, which is in the rest position, which in turn directs this higher pressure to the spring side of the 2/2-way valves 30 and 31 and thus advances the movable valve elements of the 2/2-way valves 30 and 31 to the closed position. The respective control surfaces of the 2/2-way valves 30 and 31 are dimensioned in such a way that the 2/2-way valves 30 and 31 remain closed at the same pressure in the control line C and in the pilot lines 40 and 43.

In order to be able to start up the working machine from this position of the valve arrangement with a hydraulic tool 47 connected to the working lines A1 and A2, the electrical line 37, in which a normally closed emergency stop switch 45 is also connected in series, is supplied with an operating voltage of 24 V, for example. This switches the 4/2-way valve 32 to the operating position, in which the control line C is connected to the drain T and the inlet pressure line Pa is connected to the blocked connection D. If a pressure is now applied from the hydraulic system of the working machine to the pressure line P1, for example, the 2/2 directional control valve is pressurized with the corresponding pressure via the pilot line 40. The shuttle valve 33 then directs this pressure to the drain 36 and the pre-pressure line Pa as described above, but the latter is switched to connection D in the 4/2 directional control valve 32 and is therefore blocked. The control line C is connected to the drain T and is therefore depressurized. This means that there is no pressure in the control line C that would counteract the opening of the 2/2-way valve 30. The 2/2-way valve 30 switches to the open position. A return flow is generated from the hydraulic unit 47, which leads to an increase in pressure in the working line A2. This pressure increase causes the 2/2-way valve 31 to open via the pilot line 44, so that the valve arrangement described in this respect is hydraulically permeable and the hydraulic unit 47 can be operated in the usual manner.

The same applies in the reverse case. If hydraulic pressure is first applied to the pressure line P2, the 2/2 directional control valve 31 opens first and then the 2/2 directional control valve 30 also opens via the pressure increase in the working line A1.

The valve assembly can, for example, be attached to a boom or arm of an excavator. The pressure lines P1 and P2 can then be permanently mounted as pipelines on the boom or arm and connected to the valve arrangement. The valve arrangements can each be designed as a valve block. The valve blocks are preferably attached to one side of the boom or arm, for example, where ball valves are conventionally attached. Flexible hose bends 48 and 49 extend from the valve arrangement to the hydraulic unit 47. If during operation, as described in more detail above, a hose bend 48, 49 gets caught on a protruding reinforcement bar during the demolition of a building, for example, and thus breaks off, a large amount of hydraulic oil would escape from the breakage point in conventional hydraulic systems. In such a case, the operator of the working machine can actuate the emergency stop switch 45 and thus de-energize the 4/2-way valve 32. It then falls into the rest position shown in FIG. 5. If the pressure in the hydraulic line falls below the opening pressure of the 2/2-way valve due to the leakage, the valve closes automatically. Any hydraulic pressure generated by the hydraulic system in the pressure lines P1 or P2 is then present at the shuttle valve 33. The higher of the two pressures is applied to the outflow 36 and forwarded to the control line C. Together with the spring force of the springs 39, the control line C then brings both 2/2-way valves 30 and 31 into the closed position. As a result, if a hose bend 48, 49 breaks and the emergency switch 45 is actuated, the hydraulic system in the valve arrangement is completely closed so that no further hydraulic fluid can escape from the hydraulic system.

It should be emphasized here that the valve arrangement does not replace the function of a conventional hose rupture safety device, which can also be provided directly on the two connections of the hydraulic unit 47, for example, to prevent a boom or a suspended load from suddenly dropping when a hose bend 48, 49 breaks. Such hose rupture safety devices respond automatically to a high volume flow that exceeds predetermined limit values. Basically, they are automatic, volume flow-controlled non-return valves. However, these cannot prevent large quantities of hydraulic fluid from escaping from the hydraulic system itself in the event of a hose rupture if a hose bend 48, 49 breaks.

The 2/2 directional control valves 30 and 31 can be of the same design, but preferably they are selected so that one of the 2/2 directional control valves has a larger opening cross-section than the other in order to be adapted to the different volume flows, for example in double-acting hydraulic units.

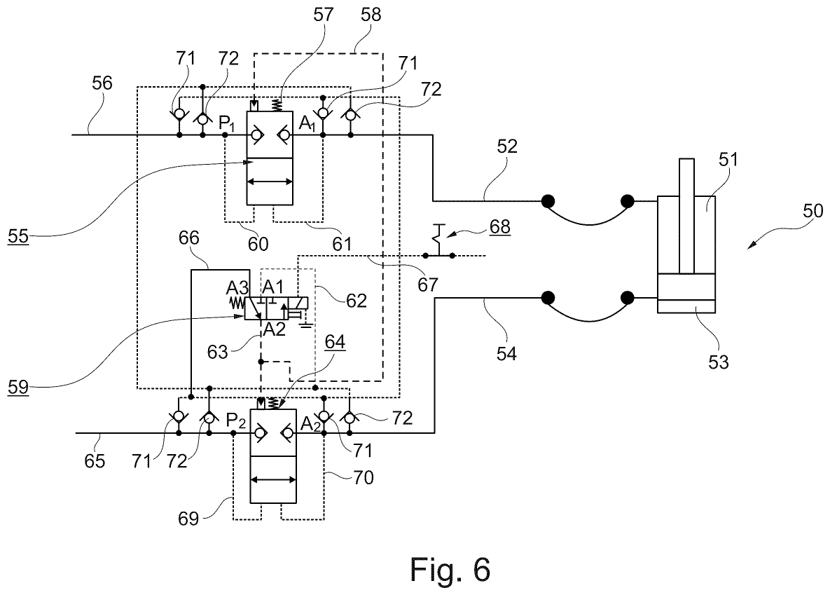

FIG. 6 shows a schematic representation of another valve arrangement with emergency stop valves. A double-acting hydraulic cylinder 50 of a hydraulic consumer includes two chambers. A first chamber 51 is connected to a first working line 52. A second chamber 53 is connected to a second working line 54. The two working lines 52, 54 are connected on the upper side to a volume control valve, not shown, which controls a volume flow through the working lines 52, 54. The volume control valve can be part of the additional valve block. The illustrated valve arrangement includes a first 2/2-way valve 55 including a port P connected to a first pressure line 56 and a port A connected to the first working line 52. In a first position of the 2/2-way valve 55, the flow from port A to P and from port P to A is blocked. In the second position, the valve 55 allows a free flow from A to P and vice versa from P to A. In the first position shown (rest position, closed position), the 2/2-way valve 55 is preloaded by a spring 57. The 2/2-way valve 55 includes a control line 58, which is connected to a pilot valve 59. The control line 58 is connected to a working chamber on the side of the spring 57 (shown as a rectangle). Depending on the technical implementation, the spring 57 can be located in the working chamber. The 2/2-way valve 55 is also controlled via the upstream pressure in the first pressure line 56 and the first working line 52. For this purpose, a pilot line 60 is provided in the 2/2-way valve 55, which extends from the first pressure line 56 to a working chamber opposite the spring 57. This is a schematic representation. The pilot line 60 can be an effective area of the piston of the directional control valve. A further pilot control line 61 extends from the first working line 52 to the same working chamber. Here too, an active surface of the directional control valve can be connected to the first working line in order to implement the functionality shown schematically. The spring 57 and the geometric design of the movable valve are selected such that the 2/2-way valve 55 switches to the open position against the force of the spring 57 at an upstream pressure of 2 bar in the first working line 52 or the first pressure line 56, for example. Electrical actuation of the 2/2-way valve 55 is not required and not provided. It is purely pressure-controlled. The 2/2-way valve 55 can be moved to the second, closed position by actuation via the control line 58. The closing pressure of the spring is preferably about 4-6 bar, and more preferably about 2 bar, for example.

The pilot valve 59 connected to the control line 58 can be designed as a 3/2-way valve. However, it is also conceivable to use a 4/2-way valve. A 3/2-way valve is shown, which in a first position includes a first connection A1, which is switched blind and which is connected to a pressure reduction line 62. A second connection A2 is connected to a control line 63, which controls a second 2/2-way valve 64 and is connected in a branch to the control line 58 of the first 2/2-way valve 55. Both 2/2-way valves 55, 64 are thus controlled by the second connection A2. The second 2/2- way valve 64 is designed analogously to the first 2/2-way valve 55 and is arranged between the second pressure line 65 and the second working line 54. The control line 63 of the second 2/2-way valve 64 acts analogously in the direction of action of the spring and transfers the valve 64 to the closed position when the control line 63 is pressurized.

A third connection A3 of the pilot valve 59 is connected to a pressure supply line 66. In the first position of the 3/2 directional control valve, a hydraulic oil flow from connection 3 to connection 2 is permitted. The control line 63 is pressurized with hydraulic oil pressure from the pressure supply line 66. In a second position of the 3/2-way valve, connection 3 is switched blind and a hydraulic oil flow from connection 2 to connection 1 is permitted. Pressure is relieved in the control line 63 and thus also in the control line 58 and the hydraulic oil flows into the pressure reduction line 62. The pilot control valve 59 is preloaded into the first position by a spring. The pilot control valve 59 can be electrically actuated via an electrical line 67. A normally closed emergency stop switch 68 is connected in series in the electrical line 67 and supplied with an operating voltage of about 24 V, for example. This switches the pilot valve 59 to the operating position, in which the control line 63 is connected to the pressure reduction line 62 and the pressure supply line 66 (also known as the pre-pressure line) is connected to the blocked connection A3. In addition, the pilot control valve 59 has an optional emergency manual override, which is structured in such a way that the pilot valve 59 can be switched to the operating position by actuating the emergency manual override.

FIG. 6 shows the first position and not the operating position of the pilot valve 59.

In the rest position shown in FIG. 6, the two 2/2-way valves 55 and 64 are therefore closed. When pressure builds up in the pressure lines 56 or 65, the respective 2/2-way valve 55, 64 is pilot-controlled into the open position via the respective pilot control line 60 or 69. At the same time, however, the highest pressure present at the four connections A₁, A₂, P₁, P₂ of the two 2/2-way valves is fed via the pressure supply line 66 to the connection A2 of the pilot valve 59 and thus to the control lines 58, 63, which in turn feed this higher pressure to the spring side of the 2/2-way valves 55 and 64 and thus pilot the movable valve elements of the 2/2-way valves 55 and 64 into the closed position. The respective control surfaces of the 2/2-way valves 55 and 64 are dimensioned such that the 2/2-way valves 55 and 64 remain closed at the same pressure in the control lines 58, 63 and the pilot lines 60, 61 and 69, 70.

The pressure supply line 66 is connected to the two working lines 52, 54 and the two pressure lines 56, 65 for this purpose. The branches to the four lines 52, 54, 56, 65 are arranged in parallel or substantially in parallel, and a non-return valve 71 is arranged in each of the branches, which opens in the direction of the pressure supply line 66 when a higher pressure is applied in each case. If, for example, the pressure line 56 is subjected to the highest pressure, the non-return valve 71 in the line branching off from the pressure line 56 opens and the parallel non-return valves 71 are thereby closed, as the pressures applied there are lower. The hydraulic oil pressure of the pressure line 56 is fed into the pressure supply line 66 and the pressure is available for the control lines 63, 58, as explained above.

In order to be able to start up the working machine from this position of the valve arrangement with a hydraulic consumer 50 connected to the working lines 52 and 54, an operating voltage is applied to the electrical line 67 and the 3/2-way valve 59 is switched to the working position. If pressure is now applied from the hydraulic system of the working machine to the pressure line 56, for example, the 2/2 directional control valve 55 arranged in the line is pressurized with the corresponding pressure via the pilot line 60. The non-return valve 71 assigned to the pressure line then forwards this pressure, as described above, to the pressure supply line 66, which, however, is switched to connection A3 in the pilot valve 59 and is therefore blocked. The control line 63 is connected to the pressure reduction line 62. In order to depressurize the control line, the pressure reduction line 62 is connected to the two working lines 52, 54 and the two pressure lines 56, 65. The branches to the four lines 52, 54, 56, 65 are arranged in parallel or substantially in parallel, with a non-return valve 72 being arranged in each of the branches, which opens in the direction of the respective one of the four lines 52, 54, 56, 65 when a higher pressure is applied in each case. If, for example, the pressure reduction line 62 is subjected to a pressure which is higher than the pressure in the pressure line 65, the non-return valve 72 opens in the line branching off from the pressure line 65 and the pressure in the control lines 63, 58 can be reduced, so that at least a lower pressure is present in the control lines 63, 58 than in the working line 56, which would counteract the opening of the 2/2-way valves 55, 64. For example, if there is a return flow from the hydraulic consumer 50, which leads to an increase in pressure in the working line 54. This pressure increase causes the 2/2-way valve 64 to open via the pilot line 70, so that the valve arrangement described in this respect is hydraulically permeable and the hydraulic consumer can be operated in the usual manner.

The same applies in the reverse case. If hydraulic pressure is first applied to the pressure line 65, the 2/2-way valve 64 opens first and then the 2/2-way valve 55 also opens via the pressure increase in the working line 52.

The valve arrangement can, for example, be attached to an upper structure of the mobile machine or, in the case of an excavator, also to a boom or arm. The pressure lines 56 and 65 can then be permanently mounted as pipelines on the boom or arm and connected to the valve arrangement. The valve arrangements can each be designed as a valve block. The valve blocks are preferably each attached to one side of the boom or arm. For example, where ball valves are conventionally attached. It is also conceivable to arrange the valve arrangement in the upper structure. Depending on how the hydraulic consumer is designed, one or more working lines are provided. For example, the hydraulic consumer can also be the boom cylinder 11, the intermediate boom cylinder 12 or the arm cylinder.

Flexible hose lines extend from the valve arrangement to the hydraulic consumer 50 in a bend. These sections are called flexible hose bends and differ from pipe bends, which are purchased as a component and have a fixed, rigid geometry. Flexible hose bends are important for movable hydraulic assemblies. If, as described in more detail above, a hose bend gets caught on a protruding reinforcement bar during the demolition of a building, for example, and breaks off, a large amount of hydraulic oil would escape from the breakage point in conventional hydraulic systems. In such a case, the operator of the working machine can actuate the emergency stop switch 68 and thus de-energize the pilot valve 59. It then falls into the position shown in FIG. 6. If the pressure in the hydraulic line falls below the opening pressure of the 2/2-way valve due to the leakage, the valve closes automatically. The higher of the two pressures in the pressure lines 56 or 65 and the leak-free working line is fed to the pressure supply line 66 and forwarded to the control lines 58, 63. Together with the spring force of the springs 57, the control lines 58, 63 then bring both 2/2-way valves 55, 64 into the closed position. As a result, in the event of a leakage in a working line, for example if a flexible hose bend breaks and the emergency switch 68 is actuated, the hydraulic system in the valve arrangement is completely closed so that no further hydraulic fluid can escape from the hydraulic system.

It should be emphasized here that the valve arrangement does not replace the function of a conventional hose rupture safety device, which can also be provided directly on the two connections of the hydraulic unit 50, for example, to prevent a boom or a suspended load from suddenly dropping when a hose bend breaks. Such hose rupture safety devices respond automatically to a high volume flow that exceeds predefined limit values. Basically, they are automatic, volume flow-controlled non-return valves. However, they cannot prevent large quantities of hydraulic fluid from escaping from the hydraulic system itself in the event of a hose bend rupture.

The two 2/2 directional control valves 55, 64 can be of identical design, but preferably they are selected so that one of the 2/2 directional control valves has a larger opening cross-section than the other in order to be adapted to the different volume flows, for example in double-acting hydraulic units or return-sensitive attachments (e.g. hydraulic hammers).

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A valve arrangement for a mobile working machine with a hydraulic consumer, the valve arrangement comprising:
at least one directional control valve connected to a pressure line and a working line of the hydraulic consumer and including a hydraulic control line structured to transfer the at least one directional control valve to a first position;
a pilot valve connected to the hydraulic control line;
a pressure supply line; and
a pressure reduction line;
the pilot valve being structured to connect the hydraulic control line alternatingly to the pressure supply line and the pressure reduction line.

2. The valve arrangement according to claim 1, wherein the first position of the at least one directional control valve is a closed position in which flow is blocked in both directions.

3. The valve arrangement according to claim 1, wherein the at least one directional control valve is biased by a spring into the first position and includes two pilot control lines connected to a working chamber opposite the spring, a first pilot control line being connected to the pressure line and a second pilot control line being connected to the working line.

4. The valve arrangement according to claim 1, wherein the pilot valve is a 3/2-way valve or a 4/2-way valve.

5. The valve arrangement according to claim 1, wherein the pilot valve is electrically actuatable and, in a rest position, connects the pressure supply line to the hydraulic control line and, in an actuated position, connects the control line to the pressure reduction line.

6. The valve arrangement according to claim 1, wherein the pilot valve is electrically actuatable in an operating position and is structured to be de-energized by an emergency stop switch.

7. The valve arrangement according to claim 6, wherein the emergency stop switch is in a working cabin of the working machine so as to be manually actuatable.

8. The valve arrangement according to claim 1, wherein the valve arrangement includes a first directional control valve and a second directional control valve, which are each connected to a pressure line and a working line of a common hydraulic consumer, the hydraulic control lines being connected to one another in such a way that the control lines pilot the two directional control valves into the closed position when the hydraulic control lines are pressurized.

9. The valve arrangement according to claim 8, wherein
the valve arrangement includes a shuttle valve with a first blockable inflow and a second blockable inflow and with an outflow, the first blockable inflow of the shuttle valve being connected to a first pressure line of the first directional control valve, the second blockable inflow of the shuttle valve is connected to a second pressure line of the second directional control valve and the outflow of the shuttle valve is connected to the pressure supply line; and
the shuttle valve is structured such that the pressure line with a highest pressure is capable of being connected to the pressure supply line.

10. The valve arrangement according to claim 1, wherein the pressure supply line is connected to the pressure line and the working line via branches arranged in parallel or substantially in parallel and each including a non-return valve structured such that a highest pressure present in the working lines and the pressure lines is conducted to the pressure supply line.

11. The valve arrangement according to claim 1, wherein the pressure reduction line is a tank line which can be connected to a tank.

12. The valve arrangement according to claim 1, wherein the pressure reduction line is connected to the pressure line and the working line via branches arranged in parallel or substantially in parallel and each including a non-return valve opening to one of the pressure lines and the working lines at lower pressure when pressure is applied in the pressure reduction line.

13. The valve arrangement according to claim 8, wherein the first directional control valve and/or the second directional control valve is a 2/2-way valve.

14. A method of using the valve arrangement according to claim 1 in a working line of a hydraulic consumer in a mobile working machine in order to shut off the working line when a leakage occurs in the working line and to reduce or prevent hydraulic oil from escaping from a leakage point.

15. A mobile working machine comprising:
a lower structure;
an upper structure;
a boom assembly; and
a hydraulic system including a hydraulic pump, a volume control valve, a hydraulic consumer and at least two hydraulic lines, the volume control valve being structured to regulate an oil flow through at least one of the at least two hydraulic lines in order to actuate the hydraulic consumer; wherein
the at least one of the at least two hydraulic lines includes a directional control valve structured to close the hydraulic line in response to a leakage of the hydraulic line.

16. The mobile working machine according to claim 15, wherein the directional control valve is located between the volume control valve and the hydraulic consumer.

17. The mobile working machine according to claim 15, wherein the mobile working machine includes a valve arrangement and the directional control valve is a portion of the valve arrangement.

18. A method for reducing or minimizing hydraulic oil loss in a mobile working machine according to claim 15 in case of a leakage of a working line, the method comprising:
if the leakage occurs in the hydraulic line between the hydraulic consumer and the directional control valve, moving the directional control valve to a shut-off position to shut off the hydraulic line;
ensuring that a locking position is maintained until the leakage has been rectified; and
after eliminating the leakage, returning the directional control valve and/or the valve assembly to an initial state before the leakage.
